(19) United States
(12) Patent Application Publication
(10) Pub. No.: US 2002/0069144 A1
(43) Pub. Date: Jun. 6, 2002

(54) METHOD AND APPARATUS FOR PROVIDING A CONSOLIDATED STORE COMPENSATION SYSTEM

(76) Inventor: KEVIN PALARDY, RESIDENCE (XP)

Correspondence Address: WARD & OLIVO, 708 THIRD AVENUE, NEW YORK, NY, 10017

(21) Appl. No.: 09/328,565

(22) Filed: Jun. 9, 1999

(51) Int. Cl. G06F 17/60

(52) U.S. Cl. 705/32

(57) ABSTRACT

The present invention provides a compensation system for designing and managing the compensation structure and human resources transactions of multi-location companies according to a company's particular business practices. Specifically, the compensation plan for each employee is designed based on each individual employee's status. For example, a store associate's hours are entered on a weekly basis in a store's Point of Sale (POS) System. The associate's sales are reported daily, along with a daily recording of any human resources transactions. This data is polled and uploaded to a central database, and the system then calculates the compensation due an employee. The compensation calculation includes base salary, commissions, overtime, premiums, bonuses and pay for time not worked. The system further provides for a bi-weekly recalculation process, whereby an employee's pay for a given period is recalculated and compared to historical pay sheets in order to determine if the compensation is consistent. The system also allows for any adjustments to be made that the recalculation process deems necessary.

### TECHNICAL FIELD OF THE INVENTION

The present invention relates generally to human resources management and operations. In particular, the invention provides an improved store compensation system for managing the compensation structure of multi-location companies—for example, retail stores with locations throughout the United States or even the world.

### BACKGROUND OF THE INVENTION

The effective operation of any business requires an accurate method for recording an employee's hours worked and human resources transactions, in order to maintain an efficient and updated payroll system. This integration of payroll and human resource information is necessary for a company to determine the compensation due each of its employees. Methods for tracking this integration have evolved from the use of a time clock system to the more modern use of highly integrated computer software.

Employee attendance and compensation records were traditionally maintained through a time clock system, in which an employee would punch a time slip into a time clock when arriving and departing from the workplace. These slips would then typically be passed along to a timekeeper, who determined the attendance and hours worked, and thus calculated the employee's wages. This arrangement, while effective in smaller settings, is not practical for a large corporate workplace, because the use of manual time cards leaves ample room for confusion and mistake. For instance, numerous handling procedures are involved, which are often complex and lend themselves to error, resulting in loss of substantial time due to constant monitoring, auditing and attention to ensure that timekeepers adhere to correct procedure. Further, such a system experiences disruption when an employee is shifted, on a temporary basis, to understaffed locations and later shifted back. Yet another disadvantage of the time clock system is its inability to be modified on an instantaneous basis, leading to problems in monitoring and regulating employee overtime. The time required for editing, error correction, time card preparation and employee record maintenance is wasteful and often jeopardizes the ability of a workplace to distribute paychecks in a timely fashion.

Numerous attempts have been made to create a more efficient time clock system. For example, Baxter, et al, U.S. Pat. No. 4,270,043 (the “'043 Patent”) describes a mark-sensitive time clock system. The '043 Patent utilizes a simple cardboard or similar card in its system, unlike other time clock patents which make use of magnetic or punched plastic badges that are interpreted by equipment sensitive to the density of the marks on these badges. A card used in the '043 Patent can be readily marked with any sort of device that can produce a mark on a piece of paper (for example, a pen, pencil or marker). The card is then read and interpreted by the time clock system without concern for the density of the mark.

Another attempt at improving the efficiency of the time clock system is found in Chalker, et al, U.S. Pat. No. 4,323,771 (the “'771 Patent”). The '771 Patent provides a process whereby each employee receives an identification badge containing an identification number. At predetermined times during the day, signaled by the ringing of a clock, the employee inserts the badge into a badge reader to record the time. In the case of loaned or borrowed employees, the timekeeper at the lending institution creates a new card for the employee, and the borrowing facility uses this separate card to keep track of the employee's attendance. The disk data storage is then mailed or carried to a central data processing center, which receives data from all of the company's facilities on a weekly basis.

With the passage of time and improvements in technology and software, systems such as those disclosed in the '043 and '771 Patents have become somewhat antiquated. Creating a payroll system is a difficult process due to the complexity of compensation calculations, which must account for federal, state and local tax laws, as well as special circumstances such as bonuses and commissions. Equally important in the calculation of employee compensation are various human resources transactions such as vacation time, sick leave and the like. Expansions in corporate size and modern technological developments mean it is often more practical and less expensive for companies to forego the time clock method and utilize computer software which can seamlessly integrate payroll and human resources to maintain employee attendance and compensation records.

Due to complexities with regard to tracking payrolls, many businesses seek the aid of outside companies that provide payroll services. These services typically include creating the payroll for each period, printing salary checks and keeping track of the payrolls. However, this arrangement can be costly, especially for small to mid-sized companies. Therefore, many businesses are forced to seek alternatives. One alternative is to purchase a commercial computer system, while another involves a company internally developing a system, designed to its specific needs, which creates and tracks payrolls as well as other human resources transactions.

Human resource activities include the hiring of new employees, tracking an employee's advancement through a company, monitoring vacation time and sick leave, as well as other typical human resources functions. As with their payroll systems, many companies have turned to computer software to update and maintain these human resources records. Unfortunately, these human resource systems suffer from substantially the same problems as the payroll systems.

Several attempts have been made at developing a system whereby payroll and human resources information are combined to generate the amount of compensation due an employee. For example, Tremaine, U.S. Pat. No. 5,819,231, (the “'231 patent”), discloses a compensation planning tool capable of receiving and storing compensation information for a plurality of employees. Such information is used to develop a compensation plan that includes current total compensation, a planned salary and a planned total compensation for each employee.

In a somewhat similar invention, Williams, U.S. Pat. No. 5,600,554 (the “'554 Patent”) recites a network-based software application for integrating payroll and human resource data. The payroll data includes an employee-type and a plurality of payroll codes, and the human resource data includes an employee-identifier for each employee, a salary for each employee, and a plurality of human resources codes. The system described in the '554 Patent system comprises four elements: 1) a means for storing the payroll data and the human resource data; 2) a means for receiving user input, including pay period; 3) a means for integrating the payroll data and the human resource data by matching the employee-type with the employee-identifier for each employee, then generating a payroll from the payroll data and the human resource data using the pay period and the salary for each employee; and 4) a means for accessing the human resource data while generating the payroll.

However, the systems disclosed in both the '544 patent and the '231 patent do not provide any internal mechanisms for verifying or corroborating the information they generate. That is, there are no mechanisms to ensure the user that the calculations are correct and that no adjustments to the payroll are necessary. Therefore, the user is forced to generate the payroll a second time, do manual calculations in order to verify the system's results, or merely rely on the first calculations. Any of these methods chosen by the user bears the potential for error, and companies may be forced to waste valuable time and money on monitoring to ensure that the calculations have been performed correctly. The lack of an internal recalculation system may drive a company to waste the valuable corporate resources of time and money, and is highly inefficient.

Therefore, a need exists for a completely integrated human resources management and payroll system which solves these problems with the existing systems. The present invention, as shown in the drawings and described in detail below, provides a system which overcomes the shortcomings of the known systems.

### SUMMARY OF THE INVENTION

Accordingly, the present invention is directed to a complete store compensation system designed as a network-based computer software application which integrates and manipulates employee payroll and human resource information. The present invention then uses such information to determine employee compensation, calculated in accordance with a company's business practices and policies. The invention also contains a mechanism for automatically recalculating the payroll generated, to determine whether any adjustments to employee compensation are necessary. The invention further facilitates ease in maintaining updated records regarding changes in employee payroll and human resource data.

Features and advantages of the present invention are set forth in the following detailed description, and in part will be realized from such description or may be learned through use of the invention. Objectives and other benefits of the invention will be apparent by the method and device referred to in the written description and claims thereof, as well as the appended drawings.

Generally speaking, this invention is directed to a system for calculating employee compensation through a combination of two processes: online design and batch design. Online design, the first step in the procedure, allows the user to design a compensation plan for each employee as determined by the employee's status, and to generate an employee job table from the information supplied to the program. Batch design, the second step of the procedure, utilizes the employee data input online to calculate each employee's compensation. The system uses modules to incorporate a variety of factors into the compensation calculation including, but not limited to, commissions, holidays, hourly rates and overtime, and calculates compensation on a weekly basis. Of course, calculation could be made using other time periods, such as bi-weekly, monthly, etc., based on the business's practices. The invention also provides a bi-weekly (or other) recalculation process, whereby an employee's pay for a given period is recalculated and compared to historical pay sheets in order to determine the consistency of an employee's compensation. Furthermore, the system allows for easy adjustment to the compensation calculation as determined through the recalculation process.

It is to be understood that both the preceding general description and the ensuing detailed description are exemplary and illustrative, and are intended to provide further explanation of the preferred embodiment of the invention as claimed. These and other advantages of the present invention will become more thoroughly apparent through the following description of the preferred embodiments and the accompanying drawings.

### BRIEF DESCRIPTION OF THE DRAWINGS

A further understanding of the present invention can be obtained by reference to a preferred embodiment set forth in the illustrations of the accompanying drawings. Although the illustrated embodiment is merely exemplary of systems for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

For a more complete understanding of the present invention, reference is now made to the following drawings in which:

FIG. 1 shows a display screen image of the menu options for the Define Store Based Compensation data entry form used in accordance with the preferred embodiment of the present invention.

FIG. 2 shows a display screen image of the Define Store Based Comp-Setup-Country data entry form used in accordance with the preferred embodiment of the present invention.

FIG. 3A shows a display screen image of the Define Store Based Comp-Setup-Compensation State Wage data entry form used in accordance with the preferred embodiment of the present invention.

FIG. 3B shows a display screen image of the menu options pertaining to State Type used in accordance with the preferred embodiment of the present invention.

FIG. 3C shows a display screen image of the menu options pertaining to Holiday State Type used in accordance with the preferred embodiment of the present invention.

FIG. 4 shows a display screen image of the Define Store Based Comp-Setup-Merchandise Departments data entry form used in accordance with the preferred embodiment of the present invention.

FIG. 5 shows a display screen image of the Define Store Based Comp-Setup-Department Groups data entry form used for arranging merchandise departments into groups in accordance with the preferred embodiment of the present invention.

FIG. 6 shows a display screen image of the Define Store Based Comp-Setup-Compensation Plan-Add panel used in accordance with the preferred embodiment of the present invention.

FIG. 7 shows a display screen image of the Define Store Based Comp-Setup-Compensation Plan data entry form used for entry of the four elements essential to the design of a compensation plan according to the preferred embodiment of the present invention.

FIG. 8 shows a display screen image of the Define Store Based Comp-Setup-Compensation Plan data entry form for creating overtime parameters in accordance with the preferred embodiment of the present invention.

FIG. 9 shows a display screen image of the Define Store Based Comp-Setup-Compensation Plan Detail-Compensation Earnings Calcs-Update/Display panel used according to the preferred embodiment of the present invention.

FIG. 10 shows a display screen image of the Define Store Based Comp-Setup-Compensation Plan Detail data entry form for entry of the earnings eligibility and calculation methods required for each job function in accordance with the preferred embodiment of the present invention.

FIG. 10A shows a display screen image of the earnings codes valid for data entry used in accordance with the preferred embodiment of the present invention.

FIG. 10B shows a display screen image of the menu options corresponding to the premium calculations codes in accordance with the preferred embodiment of the present invention.

FIG. 11 shows a display screen image of the Define Store Compensation-Setup-Compensation Plan Detail data form used in accordance with the preferred embodiment of the present invention.

FIG. 12 shows a display screen image of the data entry form used to establish commission parameters in accordance with the preferred embodiment of the present invention.

FIG. 13 shows a display screen image of the data entry form used to establish incentives for quantities of qualified SKUs and SPIFFs in accordance with the preferred embodiment of the present invention.

FIG. 14 shows a display screen image of the data entry form used for cloning an established plan in accordance with the preferred embodiment of the present invention.

FIG. 15 shows a display screen image of the data entry form used to define different compensation calculation methods in accordance with the preferred embodiment of the present invention.

FIG. 16 shows a display screen image of the data entry form used to indicate that no adjustments to calculations are necessary in accordance with the preferred embodiment of the present invention.

FIG. 17 shows a display screen image of the menu of calculations that may be selected for manual adjustment in accordance with the preferred embodiment of the present invention.

FIG. 18 shows a display screen image of the data entry form used to record or adjust a sales transaction in accordance with the preferred embodiment of the present invention.

FIG. 19 shows a display screen image of the data entry form used to adjust commission data in accordance with the preferred embodiment of the present invention.

FIG. 20 shows a display screen image of the data entry form used to update the tables that retain the historical pay data when additional pay is manually processed in accordance with the preferred embodiment of the present invention.

FIG. 21 shows a display screen image of the data entry form used to record summary data for associates in need of pay processing in accordance with the preferred embodiment of the present invention.

FIG. 22 illustrates the overall store compensation process flow in accordance with the preferred embodiment of the present invention.

FIGS. 23-25 illustrate a flow diagram of the functional design of the overall store compensation system according to the preferred embodiment of the present invention.

FIG. 26 illustrates a flow diagram of the functional design of the Store Compensation System set-up and maintenance in accordance with the preferred embodiment of the present invention.

### DETAILED DESCRIPTION OF THE PREFERRED EMBODIMENT

As required, a detailed illustrative embodiment of the present invention is disclosed herein. However, techniques, systems and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein which define the scope of the present invention.

The following presents a detailed description of a preferred embodiment of the present invention. As discussed above, the present invention relates to human resources management and operations. In particular, the invention provides an improved store compensation system for managing the compensation structure of multi-location companies—for example, retail stores with locations throughout the United States or even the world. generally to a store compensation system for calculating employee compensation according to a company's particular business practices. Specifically, the present invention provides a compensation plan for each employee designed based on each individual employee's status, as well as a method for recalculation of the compensation. Reference is herein made to the figures, wherein the numerals representing particular parts are consistently used throughout the figures and accompanying discussion.

The present invention comprises a store payroll system designed to calculate earnings for all store-based employees. The software in this invention is capable of determining employee compensation in accord with a company's business practices, and consists of two main functions: online design and batch design. The compensation plan for each employee is designed based on the employee's status. The compensation calculation involves such factors as base salary, commissions, overtime, premiums, bonuses and pay for time not worked.

The system further provides for a bi-weekly recalculation process. An employee's pay for a specific period of time is recalculated and compared to historical pay sheets in order to determine if the compensation is consistent. The system allows for any adjustments to be made that the recalculation process deems necessary.

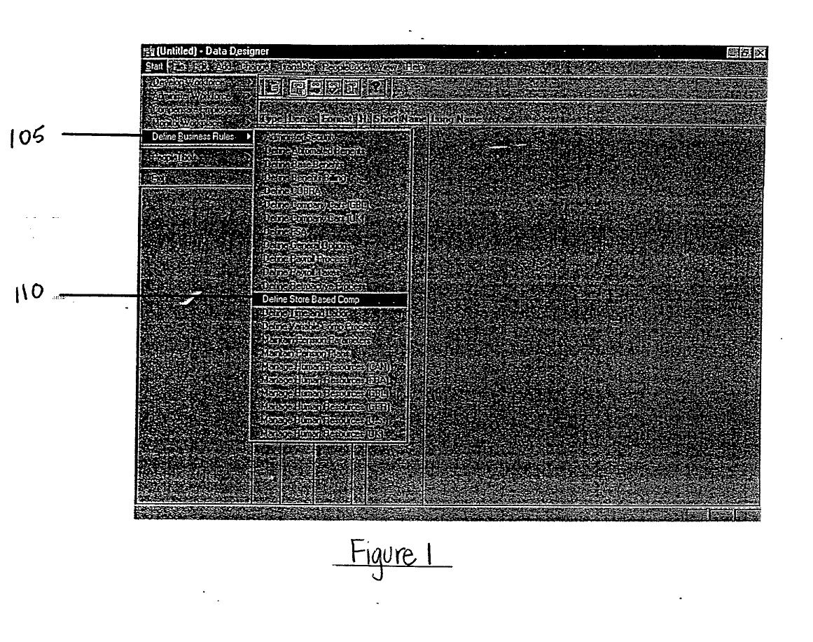

The first step in the process of establishing an employee compensation plan under the present invention is Online Design, which allows the user to design a compensation plan for each employee as determined by the employee's status, and to generate an employee job table from the information supplied to the program. Starting with the screen in FIG. 1, the user begins by entering Define Business Rules 105. This selection reveals to the user a menu of options, from which the user selects Define Store Based Comp. 110.

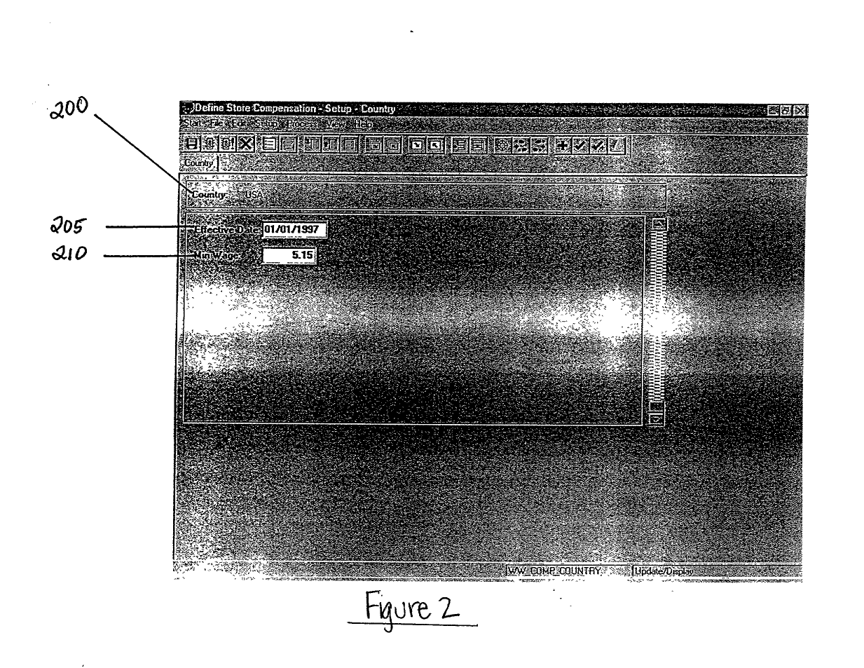

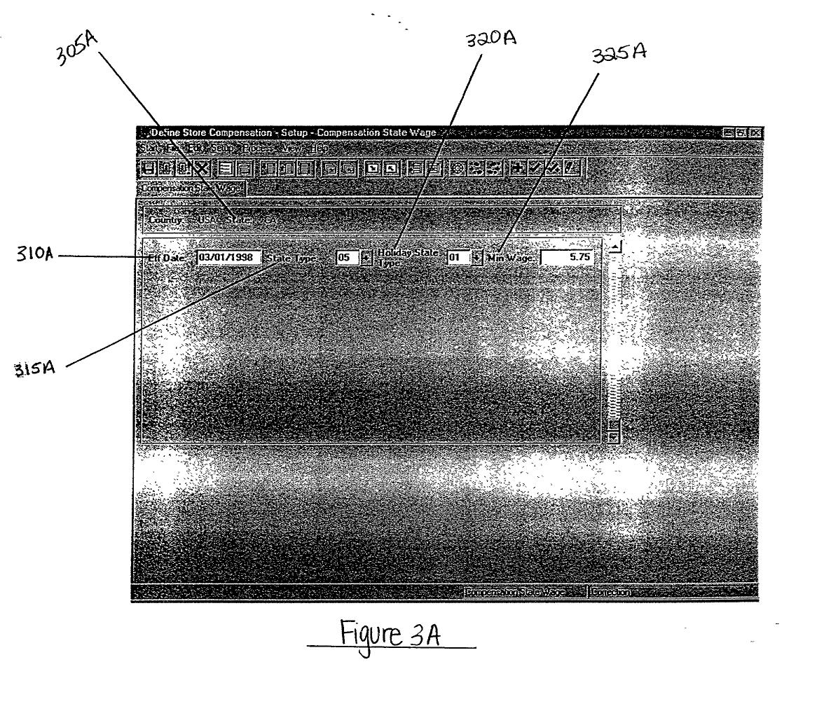

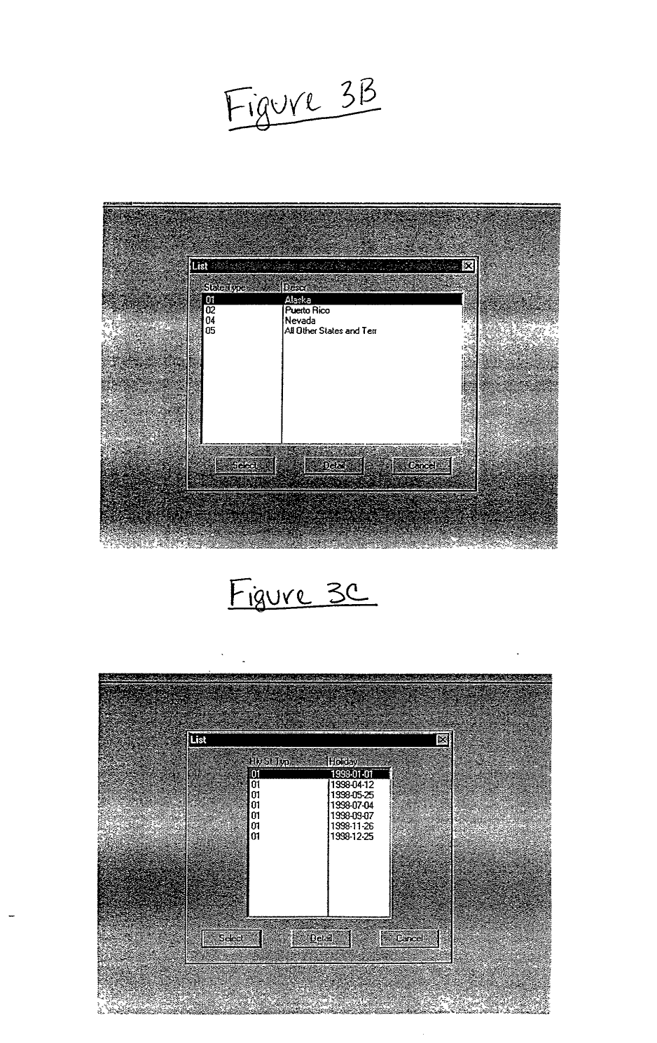

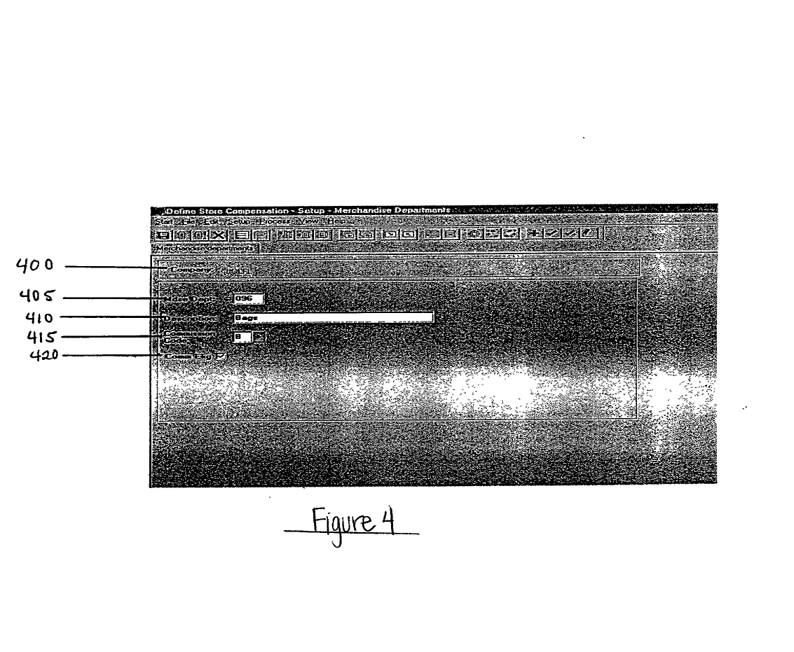

Specific criteria must be established before the compensation plan can be designed. Initially, as seen in FIG. 2, the user must identify a Country 200, an Effective Date 205, and a Minimum Wage 210. Additionally, information regarding the state of employment must be input in FIG. 3A. The user must identify the State 305A, Effective Date 310A, and the Minimum Wage 325A. Likewise, the State Type 315A must be established. The levels of state type classification are delineated in FIG. 3B. The Holiday State Type 320A must also be identified, the classifications of which are shown in FIG. 3C. A Holiday State type links each state to a Holiday table that establishes valid holidays for upcoming pay periods. Some compensation plans will contain a Holiday premium calculation that is triggered by the business date matching the table dates.

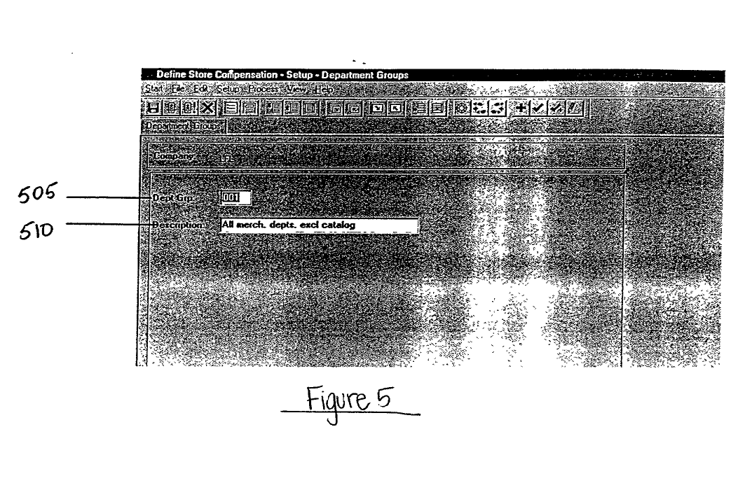

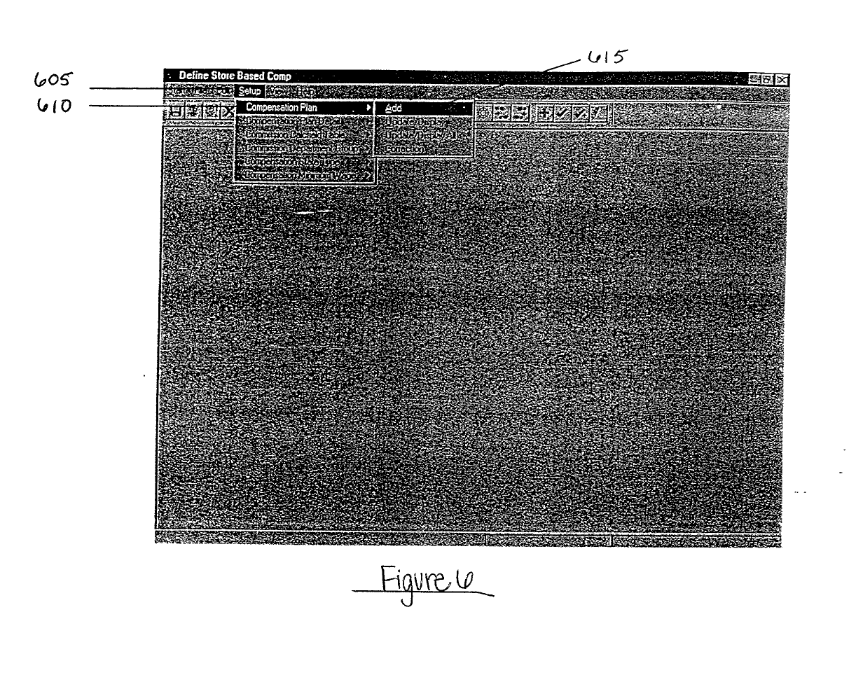

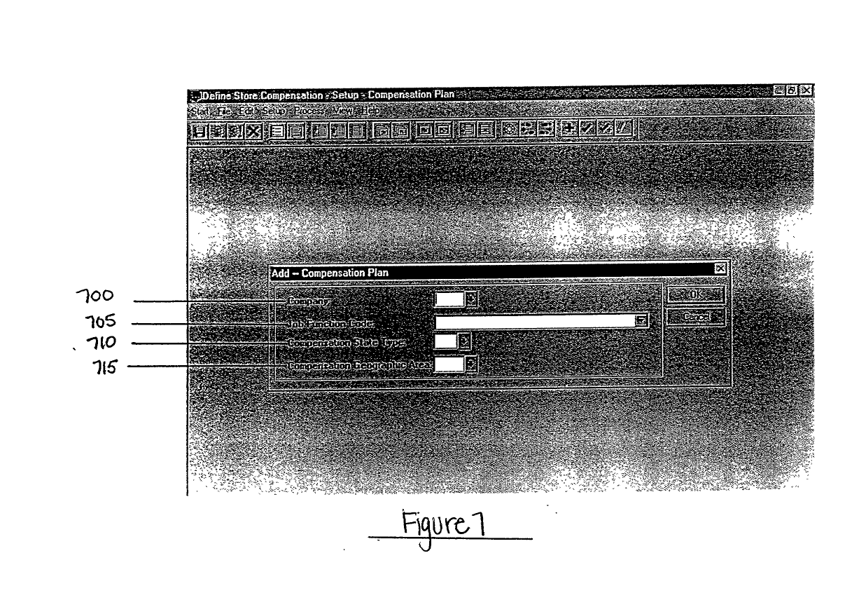

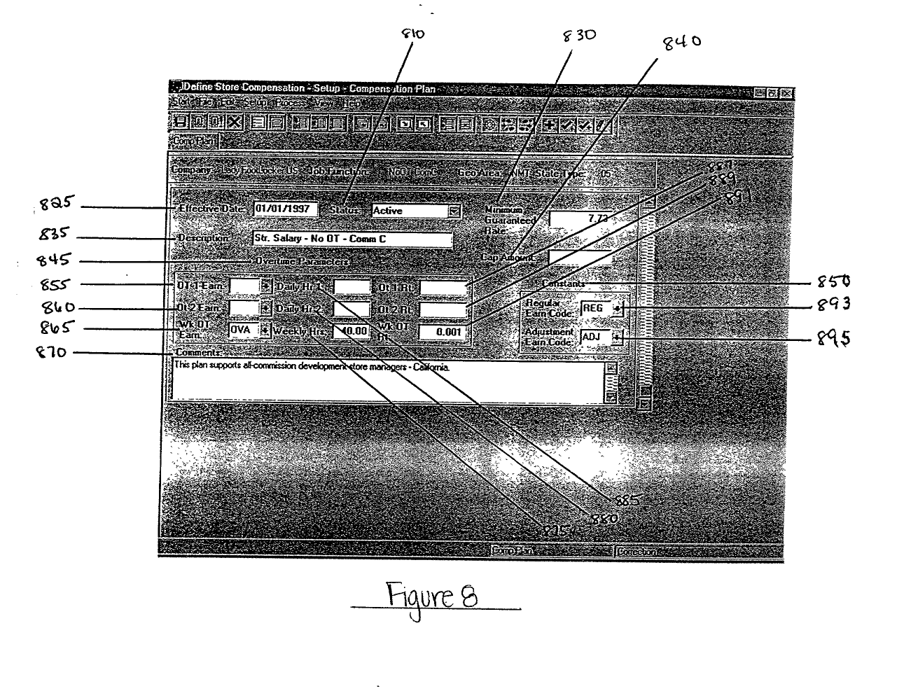

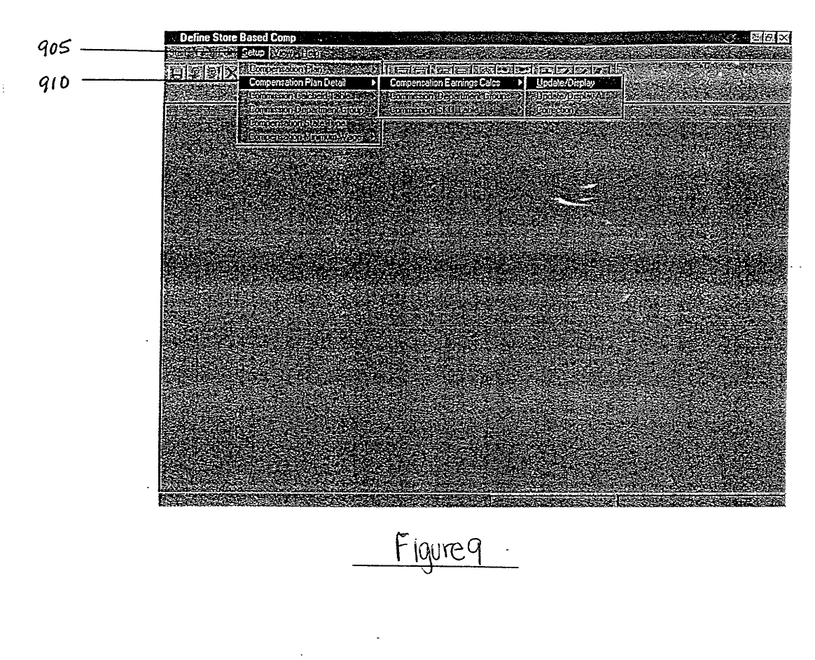

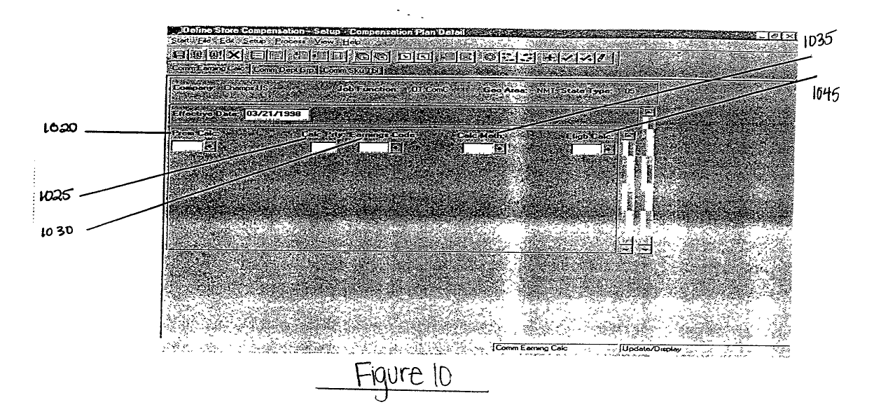

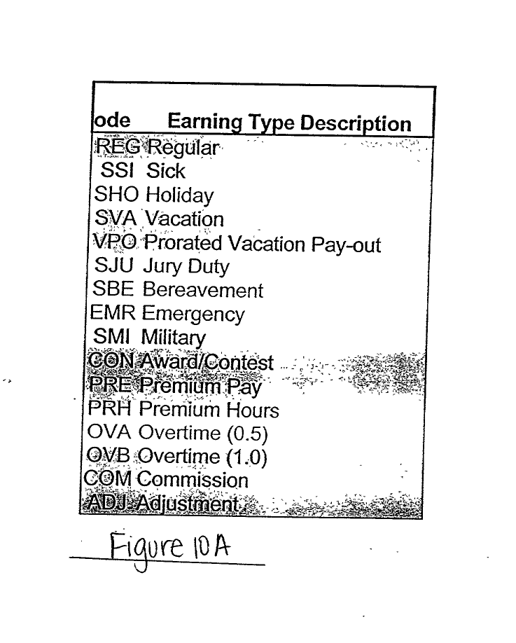

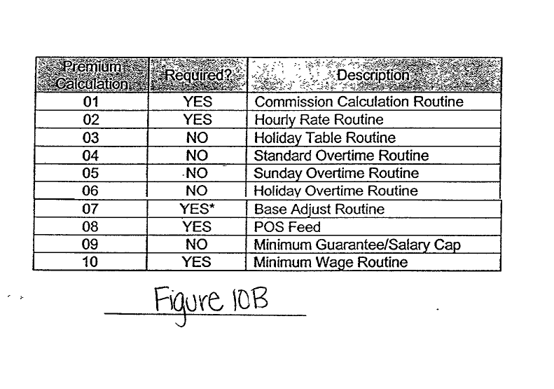

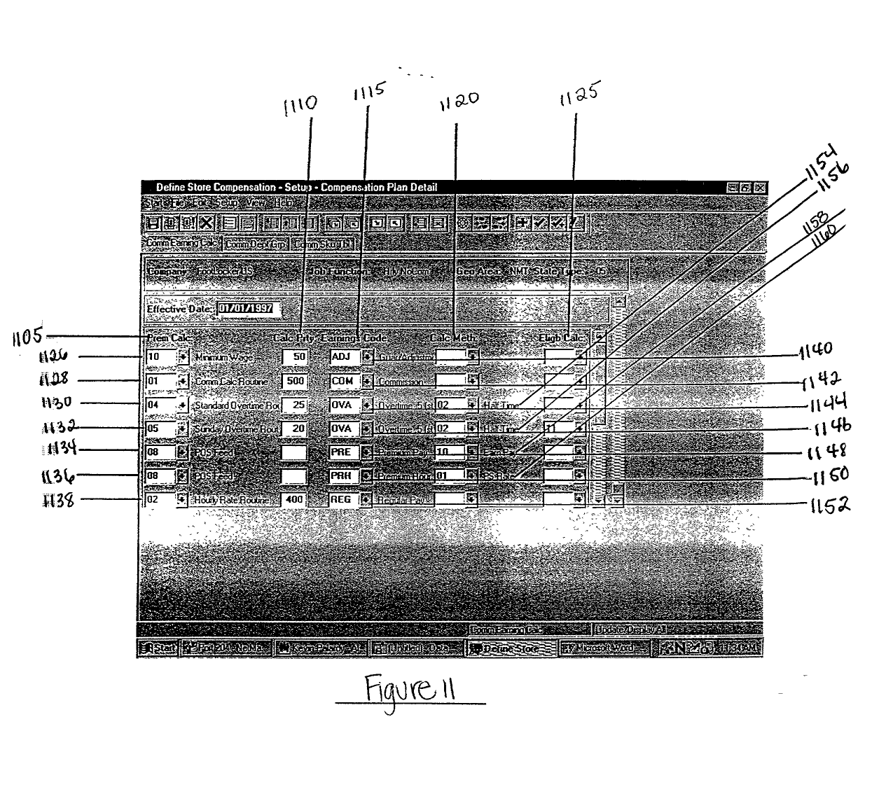

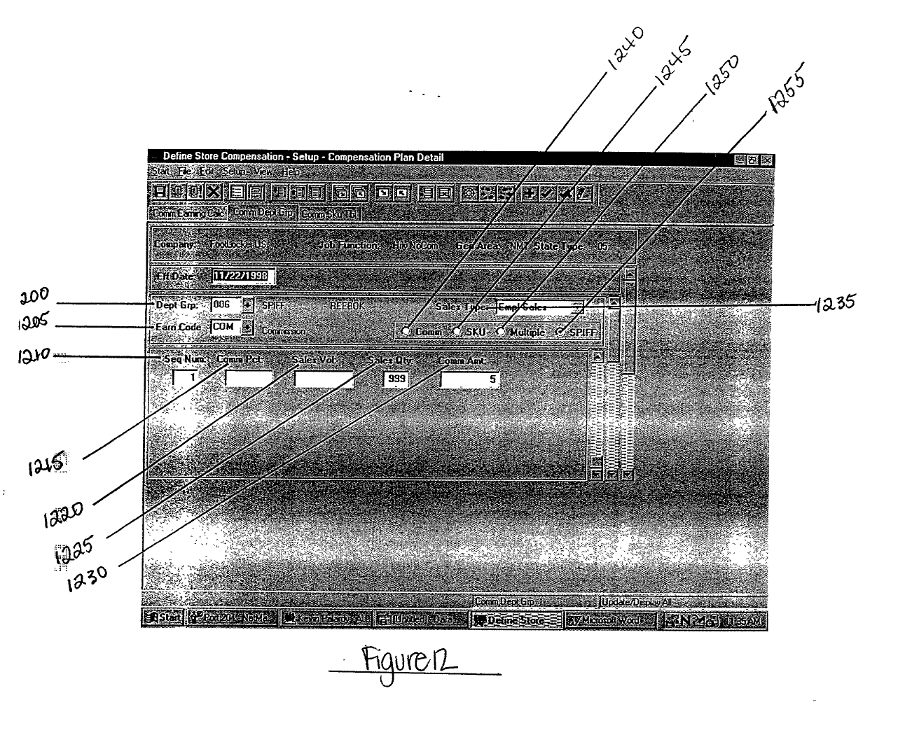

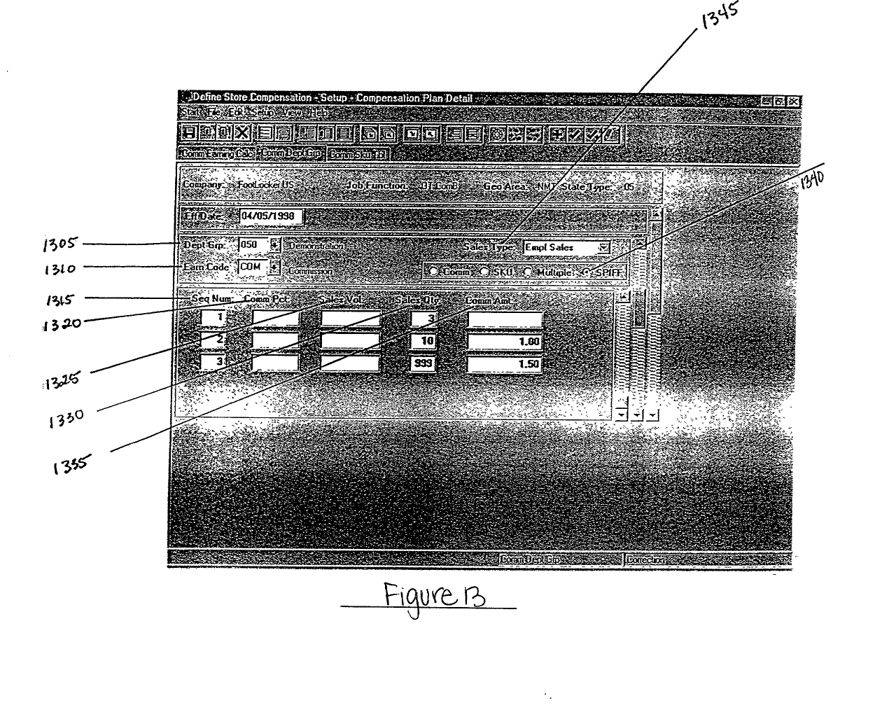

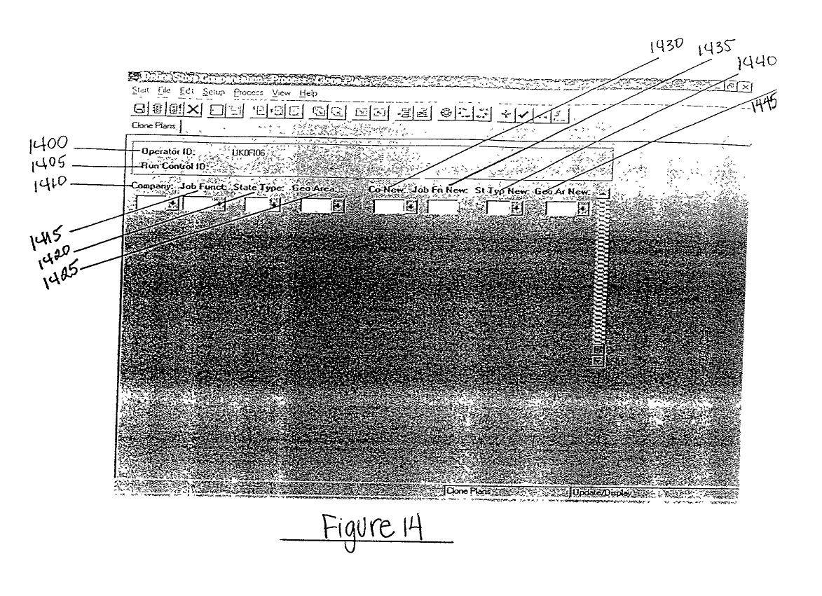

In addition to establishing business labor rules for all states, the system requires relationships to be built for Merchandise Departments in order to calculate commission earnings. While the relationships are created by management, the Store Compensation System user has the opportunity to determine the commission eligibility of the merchandise assigned to each department. The user must first configure the Merchandise Departments in the appropriate manner, as shown in FIG. 4. The user must indicate the Company 400 to which the information pertains, as well as the Merchandise Department 405, a Description 410 of the merchandise, and a Commission Code 415. The Commission Code 415 corresponds to the type of commission that belongs to the merchandise. Options include Commission Eligible, Multiple Eligible, Eligible for both Commission and Multiple or Not Eligible for Commission. The user must next select the Commission Eligible 420 box. The user may also choose to de-select the Commission Eligible 420 box, disabling commission calculations for any merchandise department.

Once the Merchandise Departments have been appropriately configured, FIG. 5 displays how they can be grouped in clusters. They are defined by the Merchandise Department Group 505 and followed by a Description 510. Here, similar departments, such as Apparel and Accessories, can be linked for calculations of special commissions designed only for these departments.

The next step in developing the compensation plan is to input the data necessary for calculating compensation. Starting at FIG. 6, the user selects Setup 605 and Compensation Plan 610 from the menu. Next, the user should select Add 615 from the available options. Upon choosing Add 615, the user is taken to FIG. 7. FIG. 7 requires the user to identify four data elements that are essential to establishing a compensation plan. Company 700 requires the user to select a three-letter code corresponding to the retail company for which the employee works. The Job Function Code 705 field requires a three-letter code for the category describing the job attached to the plan. The Compensation State Type 710 field requires a two-digit numeric code for the group of states the plan will service. Finally, Compensation Geographic Area 715 is a field designed to support future economic definitions. Only one value, “NMT,” is currently in use.

Once the four plan elements required in FIG. 7 are entered, the user is taken to the panel that appears in FIG. 8. The four plan elements appear across the top band of the screen. The Effective Date 825 will appear as the current date. It is up to the user to choose the exact operational date and Status 810 of the plan. The plan should be named in the Description 835 field, and a “Comments” 870 section is available to add documentation detail. Overtime Parameters 845 must be established for each plan. Overtime earnings codes (OT 1 Earn 855 and OT 2 Earn 860) are attached to daily hour triggers (Daily Hr 1 885 and Daily Hr 2 880) and rates of overtime pay (Ot 1 Rt 887 and Ot 2 Rt 889). The fields Wk OT Earn 865, Weekly Hrs 875, and Wk Ot Rt 891 all provide defaults for the weekly calculation method. These definitions establish overtime eligibility as defined by law and drive the weekly calculation process. The Minimum Guaranteed Rate 830 field can be used to override the state or federal minimum wage amounts currently in effect. The Cap Amount 840 field can be used to limit earnings derived from commissions to either a maximum hourly rate or maximum fixed amount for a week. The Constants 850 appear on the screen as Regular Earn Code 893 and Adjustment Earn Code 895.

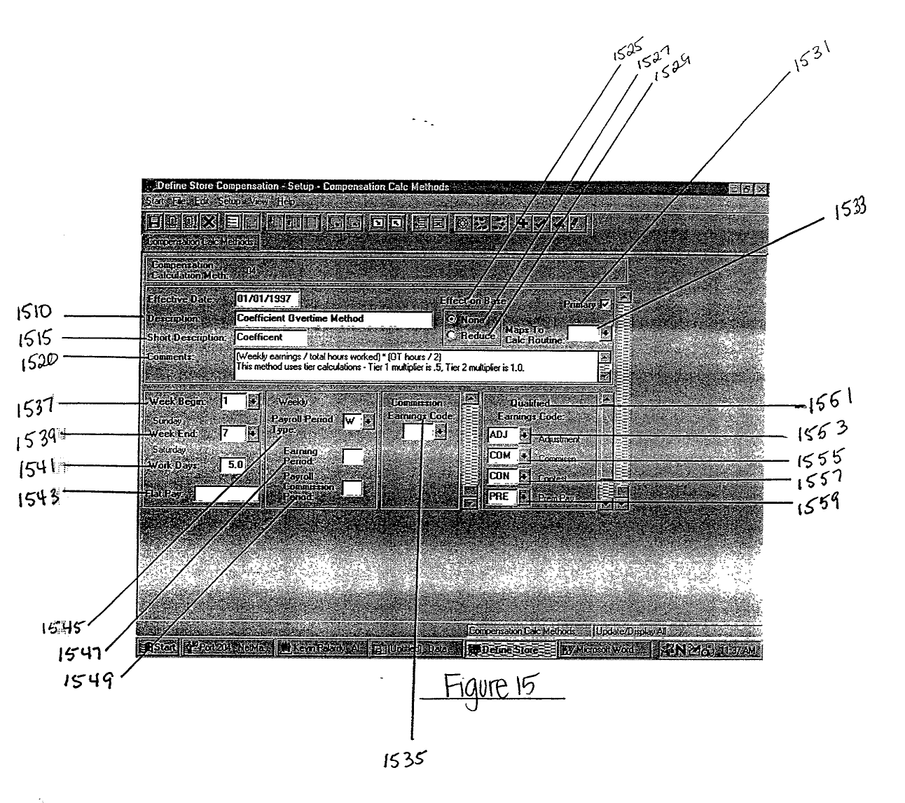

The next step in the compensation plan design process is to add detail to the plan. As seen in FIG. 9, when selecting Setup 905, the user is provided with a menu of options. From the menu, the user selects Compensation Plan Detail 910, which takes the user to FIG. 10. The Compensation Plan Detail panel, shown in FIG. 10, allows the user to define the earnings eligibility and appropriate Calculation Method 1035 required for each job function in a company. Calculation Method 1035 parameters are set in FIG. 15, discussed below. In addition, the user will attach an Earnings Code 1030 to each eligible earning type, prioritize the calculation routine by selecting Calc Prty 1025, and, in some cases, attach an eligibility routine (Eligb Calc 1045) that will search for additional criteria before calculating amounts to be paid. When the user selects Earnings Code 1030, a menu of options appears, shown in FIG. 10A. The lightly shaded earnings types in FIG. 10A would be required of almost any compensation plan and many plans will require all of the earnings types listed. The user defines the plan according to the policies that govern eligibility. The user must also assign a premium calculation in the Prem Calc 1020 field to each earning type selected. When the user selects Prem Calc 1020, a menu of options appears, shown in FIG. 10B, from which the user may choose.

When the user has input all required data into the screen shown in FIG. 10, the user may display all of the information in FIG. 11. The user can observe information regarding Minimum Wage 1126, Commission Calculation Routine 1128, Standard Overtime Routine 1130, Sunday Overtime Routine 1132, Point of Sale Feed 1134, Point of Sale Feed 1136, and Hourly Rate Routine 1138, along with the Premium Calculation Number 1105 assigned to each. Additionally, FIG. 11 displays the Calculation Priority 1110 which attaches to each calculation. Likewise, the Earnings Codes 1115 are shown, and include Guarantee/Adjustment (ADJ) 1140, Commission (COM) 1142, Overtime 0.5 (standard) (OVA) 1144, Overtime 0.5 (standard) (OVA) 1146, Premium Pay (PRE) 1148, Premium Hour (PRH) 1150, and Regular Pay (REG) 1152. The Calculation Method 1120 for each calculation is also shown in FIG. 11, and includes Half Time 1154, Half Time 1156, Earn Pay 1158, and PS Rate 1160. Finally, the eligibility routine that searches for additional criteria before calculating amounts to be paid is displayed in the Eligb Calc 1125 field.

The next step in building the compensation plan is to establish the commission parameters approved for each job function. By selecting Commission Plan Detail from the Setup menu, the user is taken to the screen displayed in FIG. 12. On this data screen, the Department Group 1200, Earnings Code 1205, and Sales Type 1235 are displayed. The user can select whether to set the parameters for standard Commissions 1240, SKU 1245 incentives, Multiple Commissions 1250 or SPIFF incentives 1255. The user then establishes the restrictions on each commission type by inputting a Sequence Number 1210, Commission Percentage 1215, Sales Volume 1220, Sales Quantity 1225 and Commission Amount 1230. If the user selects Multiple 1250, then the plan will be designed to pay a commission percentage on multiple commission sales. These sales transactions are identified by a “YES” or “NO” indicator when polled and recorded. The plan sums all of the “Yes” responses and computes a commission.

The Compensation System also provides the opportunity to establish incentives for quantities of qualified SKUs and SPIFFs, as seen in FIG. 13. One can also qualify earnings by levels of quantities sold. The user needs to indicate the Department Group 1305, Earnings Code 1310, Sales Type 1345, and the type of incentive program (SKU or SPIFF) at 1340. The user may then designate a Sequence Number 1315, as well as a Commission Percentage 1320 that attaches to a corresponding Sales Volume 1325 and Sales Quantity 1330. The resulting Commission Amount 1335 is then calculated. The user can establish that the commission payments occur in tiers, so that the employee earns higher commissions as the quantity of merchandise sold increases.

The compensation system also provides for an efficient method of duplicating a compensation plan by cloning it from an established plan, shown in FIG. 14. The user simply needs to input an Operator ID 1400, and identify the four key components of the plan to be copied: Company 1410, Job Function 1415, State Type 1420 and Geographic Area 1425. The user must then identify the new components of the new plan: Company New 1430, Job Function New 1435, State Type New 1440 and Geographic Area New 1445. Clicking on the “Run” 1450 icon and identifying the Run Control ID 1405 creates the plans. This feature would be used if a new state type were developed, creating a need for new plans to be established. Should a new company be added to the corporate tree, this function would save many hours of design work.

Once the necessary information has been input, the user can define different compensation calculation methods using the panel shown in FIG. 15. A Description 1510, as well as a Short Description 1515 and any additional Comments 1520 must be included. The user inputs data into the Effect on Base 1525, None 1527, Reduce 1529, Primary 1531, and Maps To Calc Routine 1533 fields. Information must also be provided for the Week Begin 1537 and Week End 1539 fields, as well as the Work Days 1541 and Flat Pay 1543 fields. Additionally, the user must indicate the Payroll Period Type 1545, Earning Period 1547, Payroll Commission Period 1549, Commission Earnings Code 1535, and Qualified Earnings Codes 1551 (Adjustment 1553, Commission 1555, Contest 1557 and Premium Pay 1559).

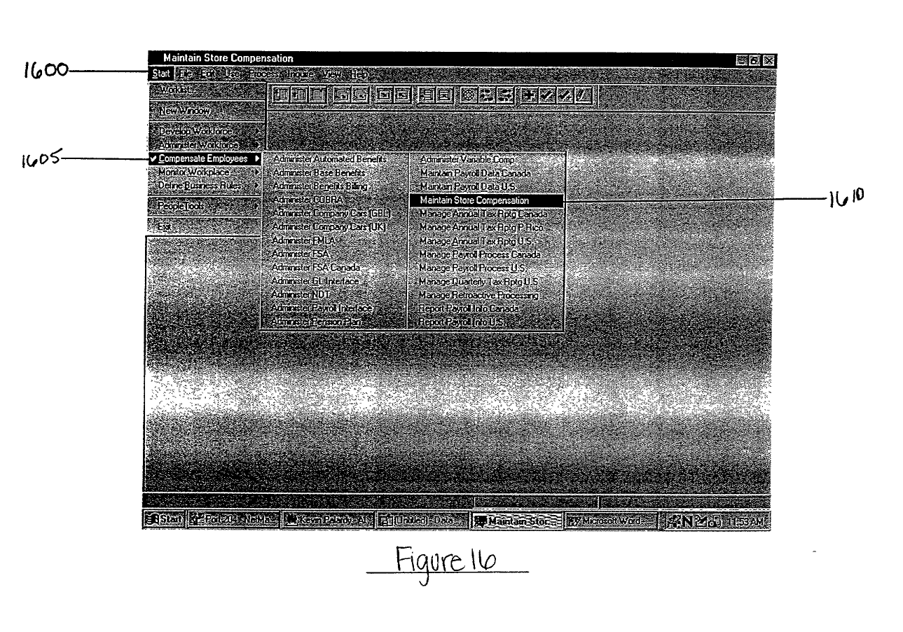

The compensation system uses data polled nightly from the Point of Sale system. Through joining data elements linked by an employee's social security number and storing the data in tables, the system can accurately calculate commissions and report the data back to the source. When this data is missing or reported to be inaccurate, the payroll must be adjusted and earnings recalculated. If the calculations reveal that no adjustments are necessary, the system will maintain the compensation statistics. As shown in FIG. 16, by selecting Start 1600, Compensate Employees 1605 and Maintain Store Compensation 1610, the user can tell the system that no changes to the calculated commissions are needed.

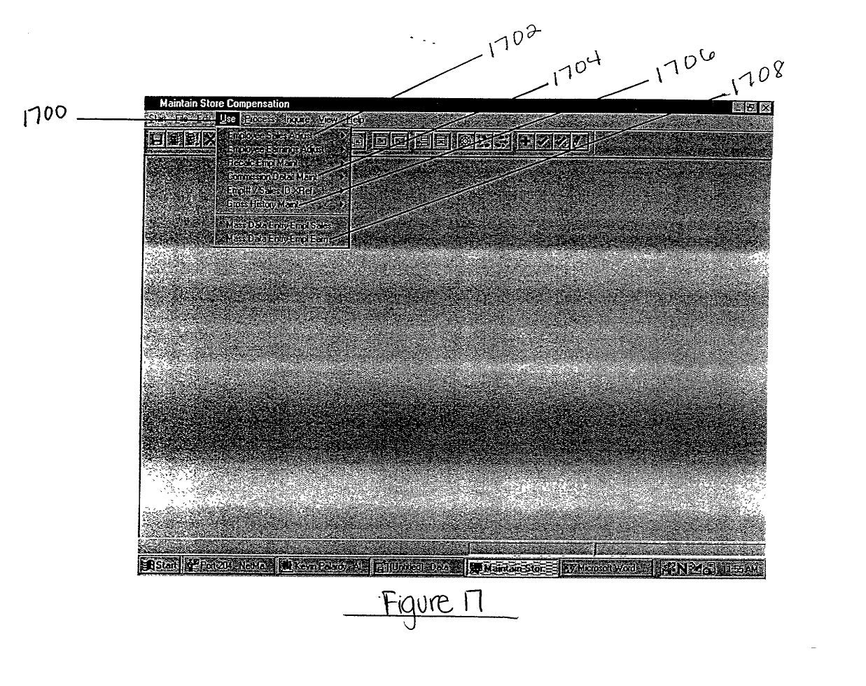

If adjustments to the calculations are required, the user can make the changes manually by selecting Use 1700, seen in FIG. 17. From the menu of options listed, the user can select the fields which require changes.

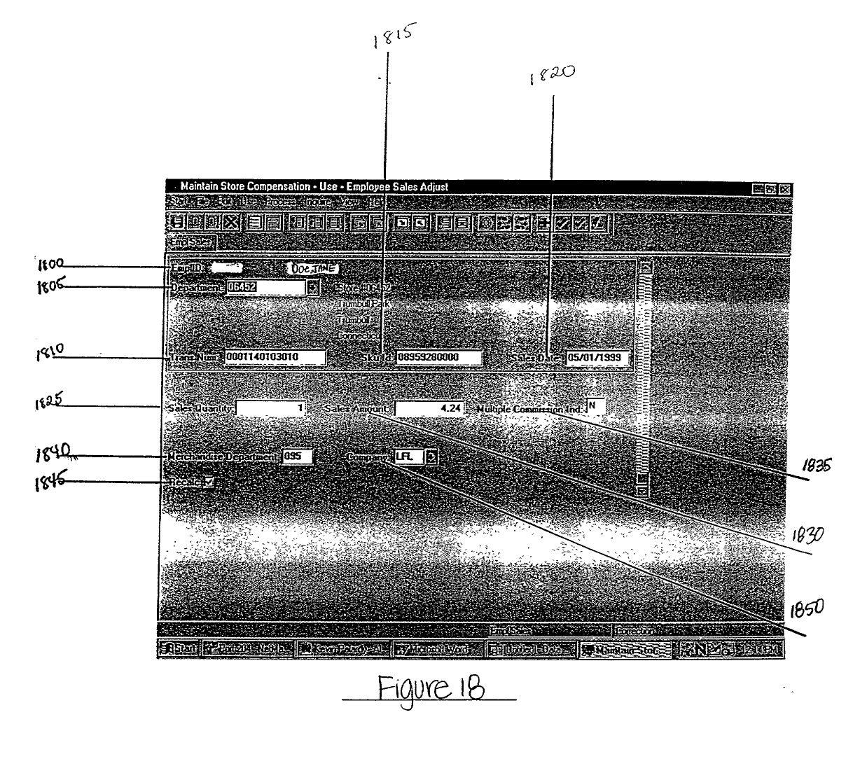

Selecting Employee Sales Adjust 1702 takes the user to FIG. 18, which allows the operator to record or adjust a sales transaction. The user must indicate the Employee ID 1800 and the Department 1805 in which the employee works. Next, the Transaction Number 1810, SKU ID 1815 and Sales Date 1820 must be provided. The user then must input the new information: the Sales Quantity 1825 sold by the employee, the Sales Amount 1830, and whether the item sold was subject to a Multiple Commission 1835. Additionally, information regarding the Merchandise Department 1840 and Company 1850 from which the item was sold is needed. Finally, the operator must indicate that the compensation recalculation may proceed by selecting Recalc 1845.

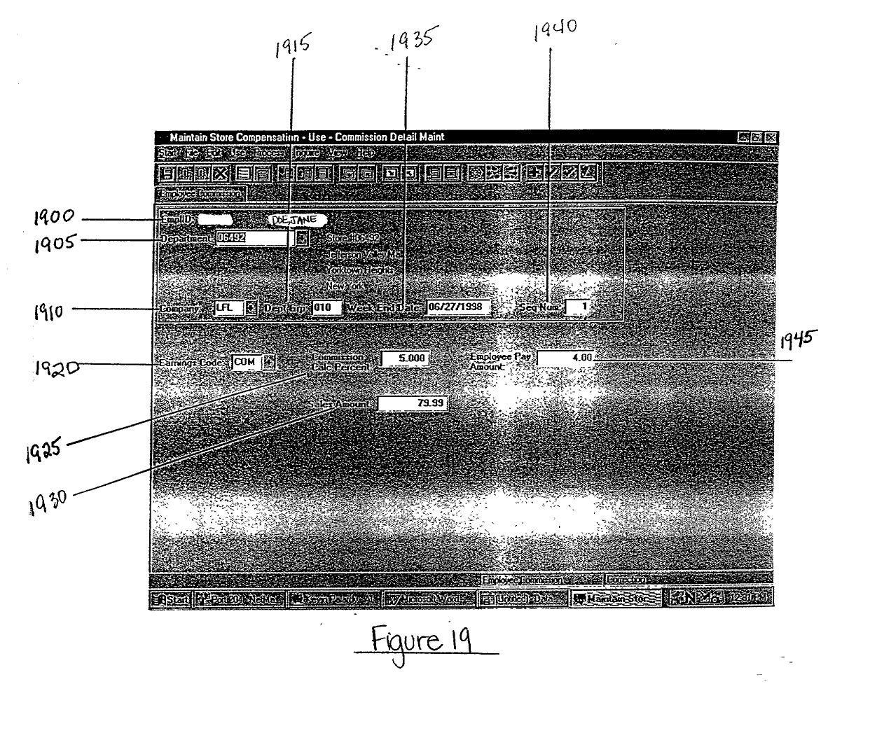

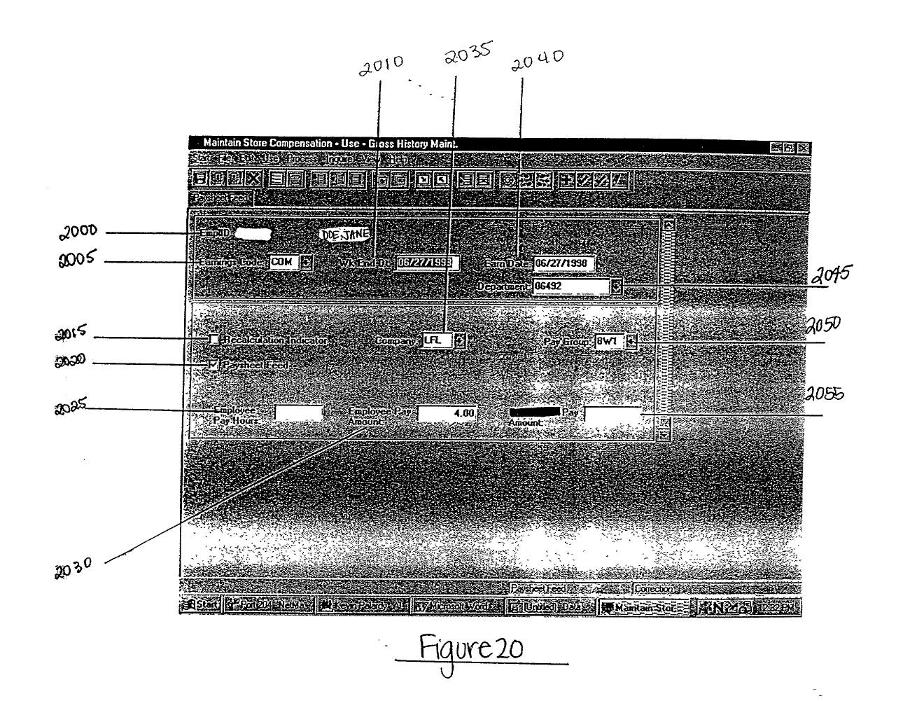

Selecting Commission Detail Maintenance 1704 from the Use 1700 menu in FIG. 17 will take the user to FIG. 19. This panel allows commission data to be adjusted. The user must indicate the Employee ID 1900 and Department 1905, as well as the Company 1910, Department Group 1915, Week End Date 1935 and Sequence Number 1940. Next, the Earnings Code 1920, Commission Calculation Percentage 1925 and Sales Amount 1930 are input. This information is used to calculate the additional commission due the employee, as shown in the Employee Pay Amount 1945 field. If the user selects Gross History Maintenance 1706 from the Use 1700 menu in FIG. 17, the panel shown in FIG. 20 will be displayed. This panel allows an operator to update the tables that retain the historical pay data when additional pay is manually processed. The Employee ID 2000 is displayed, and the user must indicate an Earnings Code 2005, Week End Date 2010, Earn Date 2040 and Department 2045, as well as the name of the Company 2035 for which the employee works and the Pay Group 2050 to which the employee belongs. The user then needs to identify whether the new data was used to recalculate the compensation due the employee 2015, and whether it must be included in a Paysheet Feed 2020. Additionally, the user must update the additional Employee Pay Hours 2025 and Employee Pay Amount 2030. The new total compensation is indicated in Pay Amount 2055.

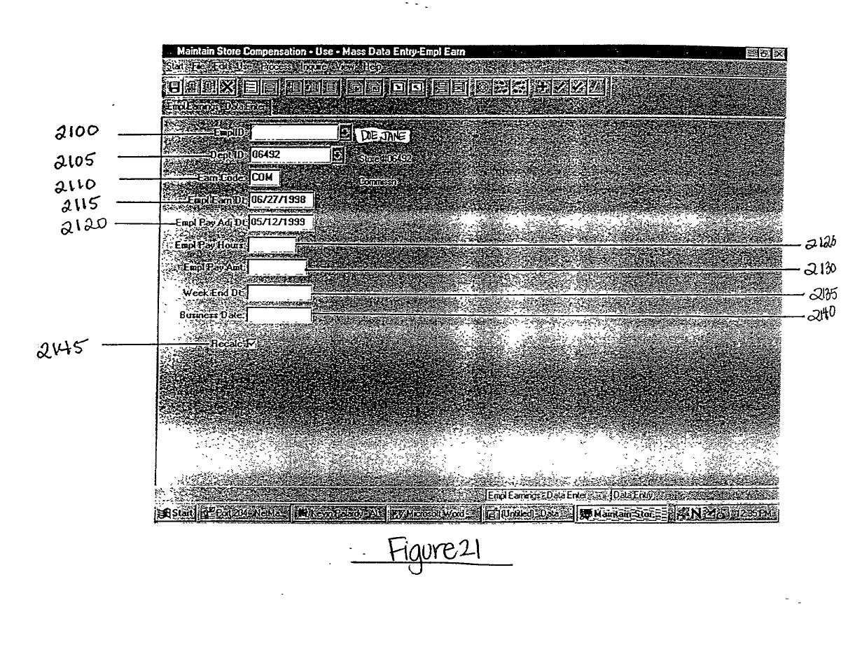

Finally, by selecting Mass Data Entry—Employee Earnings 1708 from the Use 1700 menu in FIG. 17, the user is taken to the panel in FIG. 21. This panel allows the operator to record summary data for associates in need of pay processing. It is used when pay deadlines are near and a large volume of earnings data is missing. The user must input the Employee ID 2100, Department ID 2105, Earnings Code 2110, Earnings Date 2115, and Pay Adjustment Date 2120. The new information is indicated in the Employee Pay Hours 2125 and Employee Pay Amount 2130 fields, as well as the Week End Date 2135 and Business Date 2140. Finally, the user must inform the system that Recalculation 2145 is necessary. After completing the information fields in FIG. 21, the user can later retrieve the panel shown in FIG. 20 to record the other detail data not captured in FIG. 21.

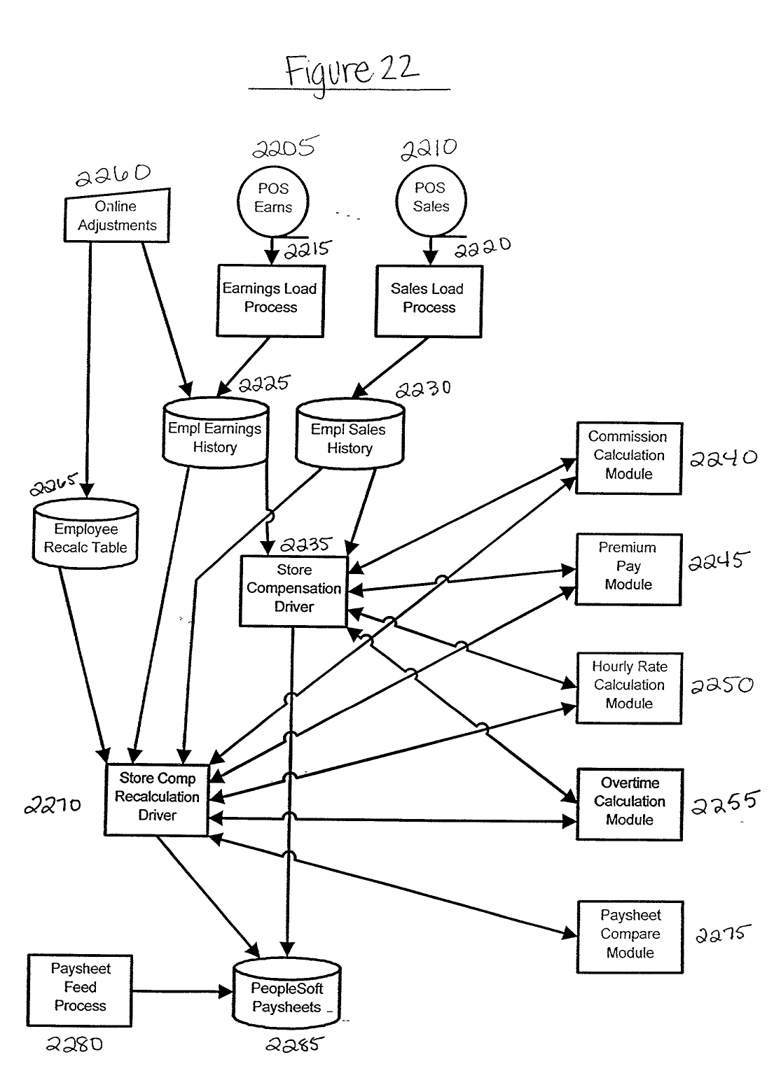

The next major process of the present invention is batch design, which involves utilizing the employee data input during online design to calculate the compensation due each employee. FIG. 22 is an illustration of the flow of this process. Initially, a user enters the hours an employee has worked into the Point of Sale System at the store register in which the hours were worked, indicated by POS Earns 2205. A store associate will record his or her sales at the store register, indicated by POS Sales 2210. Sales Load Process 2220 is responsible for loading the sales history table via a sequential file received from the store interface process. The batch feed determines if the sales information being received is for a prior pay period. If the sales are related to a previous pay period, the process will recognize that situation and insert a row into the Employee Recalculation Table 2265. Current pay period sales are inserted into the Empl Sales History 2230 table without an entry to the Employee Recalculation Table 2265.

Earnings Load Process 2215 is responsible for loading the earnings history table via a sequential file received from the store interface process. The batch feed occurs daily, and determines if the earnings information being received is for a prior pay period. If earnings are related to a previous pay period, the process will recognize that situation and insert a row into the Employee Recalculation Table 2265. Current pay period earnings are inserted into the Empl Earnings History 2225 table without an entry to the Employee Recalculation Table 2265.

The Store Compensation Driver 2235 represents the majority of the functionality that the store based compensation system will deliver. Its predominant function is to determine commission amounts and hourly rates for earnings codes for each store employee, using the Earnings History 2225 and Sales History 2230 information. The driver in this process is an employee job table.

All active employees with a jobcode associated with store operations will be processed. As each employee is read, the Commission Calculation Module 2240 is called to determine commission amounts valid for the employee, and to calculate the dollar amount associated with each type of commission. The module will be passed employee number, company, jobcode, state type and pay period begin and end dates. The employee number, jobcode and state type are from the employee job table, all input during the online design process. The company, jobcode and state type are used as keys to their compensation plan. A sales type of weekly delineates store weekly sales, while employee sales type involves employee weekly sales. The employee number will be used to retrieve sales for the employee from the Sales History 2230 table for the period in question. As each sales row is read, the company and state type fields on the sales records are used to override the corresponding keys on their compensation plan. Since sales are grouped by company, state type and department group when read from the Sales History 2230 table, the department group sales amounts are summed and the department group is used as a key to the commission department group table. If a match exists, the sales type field is used to determine the range of values the data will contain on the commission department group table. If no match exists (no sales records), the default keys are used.

The annual sales type involves store annual sales. In this case, the annual sales of the store are derived by totaling the sales for the year for the home store number of the employee. A sales type of average involves an algorithm to determine employee weekly sales. For sales types of weekly, average and annual, the sales figure is matched against the sales volume field on the commission department group table and the corresponding percentage is multiplied by the sales figure to arrive at the commission amount. For employee sales type, the process is graduated. As sales thresholds are met, new commission percentages are used for the sales amount that is within the sales volume ranges.

This module also processes SKU incentives. If a department group is associated with SKU incentives on the compensation plan, the SKU table is accessed to determine if there are active SKU incentive programs. If there are active programs, SKU numbers are read from the SKU table and joined to the sales history table obtaining sales for all valid SKU numbers within the pay period dates for the employee. The resulting amount is multiplied against the commission percentage to obtain the SKU commission amount.

Another commission calculated by this module is a SPIFF. A SPIFF is processed in the same manner as a SKU, with the exception that the percentage is a fixed dollar amount and the sales volume is an item count. As the SPIFF table is checked for active plans, the SKU numbers are searched on the sales history table. Counts are totaled for all active SKU numbers and the count is bumped against the commission department group table to get the corresponding dollar amount per unit. This dollar amount is then multiplied by the number of units within that range. As the commission amounts are calculated for all types, they are matched to an earnings code, and the earnings code and dollar amounts are stored in an internal table that are returned to the calling program.

After a commission is calculated, the next step in the process is to call the Premium Pay Module 2245, to determine if any holidays exist for the employee for the pay period date range, and to check for any regular time worked on those dates for the purposes of calculating premium pay. This module will be passed employee number, company and pay period dates. With those keys, the holiday schedule for the employee will be checked for any dates that are holidays. If dates are selected, the earnings history table is used to select any regular time that was worked on those dates. These hours worked are attached to the premium pay earnings code and are returned to the calling program.

Next, the Hourly Rate Calculation Module 2250 is called to calculate an hourly rate associated with the various earnings code for the employee for the pay period date range. This figure is calculated via a pre-determined calculation method. The module will be passed employee number, company, jobcode, state type, pay period begin and end dates and call type. With these keys, the earnings calculation table will be accessed to get the domain of earnings types that require hourly rate calculation. This domain is determined by the call type, regular or exception. These earnings are read from the earnings history table and the calculation method algorithm is used to determine the hourly rate for each earning code. The hourly rate is then multiplied by the number of hours to obtain the dollar amount. The earnings codes and dollar amounts are returned to the calling program via an internal table.

The next module, Overtime Calculation Module 2255, is called to determine the overtime that is earned for the pay period date range. The module will be passed employee number, company, jobcode, state type and pay period begin and end dates. The Earnings History 2225 table is read for all regular earnings by day. All hours greater that eight per day are added into overtime for that day. All hours greater than forty per week are added into overtime for the week, if not included in the per day amounts. The result is an overtime earnings code and hours that are returned to the calling program. The final step in the Compensation Calculation Process 2235 is to calculate the hourly rate for time not worked, which is determined via the Hourly Rate Calculation Module 2250.

The results of the aforementioned modules are earnings codes, hours and dollar amounts that are stored to a temporary table, via a module, with keys of employee number and pay period end date. The last process in the main driver section reads this temporary table for the employee and inserts the data into paysheets for the pay period in question.

When the Compensation Calculation Process 2235 is completed and the resulting data is inserted into paysheets for the applicable time period, the store compensation program begins the Recalculation Process 2270. The purpose of this process is to recalculate an employee's pay for a given pay period, and to compare the earnings amounts in detail to the historical paysheets to determine if the pay is the same. The aforementioned necessary Online Adjustments 2260 can be made, if an employee's Earnings History 2225 must be updated or corrected. If an adjustment is needed, an adjustment earnings code is generated for the current pay period.

The Recalculation Process 2270 uses the Employee Recalculation Table 2265 as its driver. This table contains the employee number and the pay period in which the adjustment was made. With that information, the modules in the compensation process will be called to replicate the compensation calculation process.

Next, the Paysheet Compare Module 2275 will be called to compare the temporary table of earnings and dollar amounts with that on the historical paysheet for the recalculation pay period. The module will be passed employee number, company and pay period end date. With these keys, the employee's historical paysheets will be selected and the earnings will be compared for similarity. Any differences will generate an adjustment earnings code for the amount of the difference. The earnings code and adjusted differed will be returned to the calling program. The last process in the main driver routine will take the resulting adjustment transaction and insert it into the current period paysheet.

The Paysheet Unfeed Process 2280 is designed to undo the front end feed of earnings from the store compensation system. A preliminary pay calculation is needed for reporting and validation purposes, and it is necessary to provide a feed of front information for this preliminary cycle. Since the data can change on the front end of the system due to circumstances such as current period adjustments or missing sales information, the initial feed of information must be erased in order to generate a final feed of inclusive data.

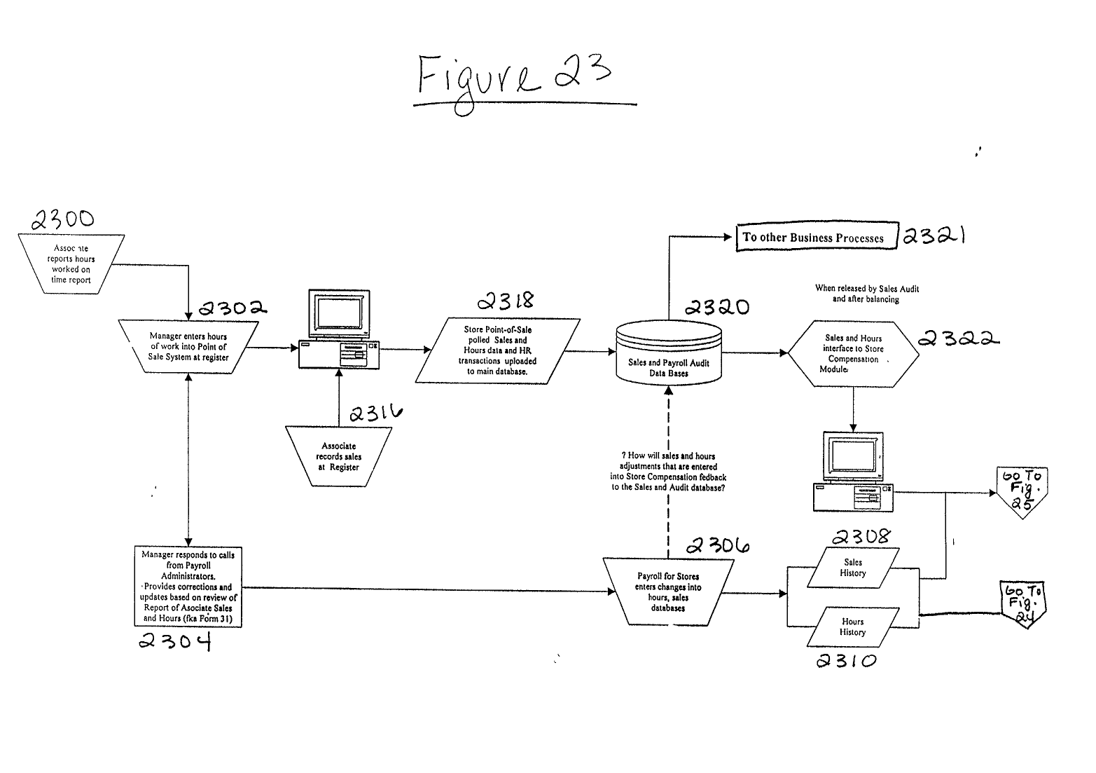

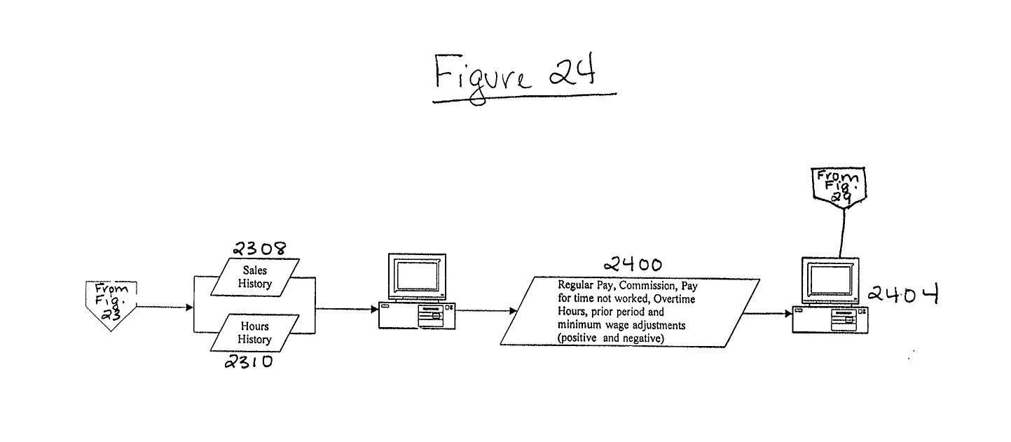

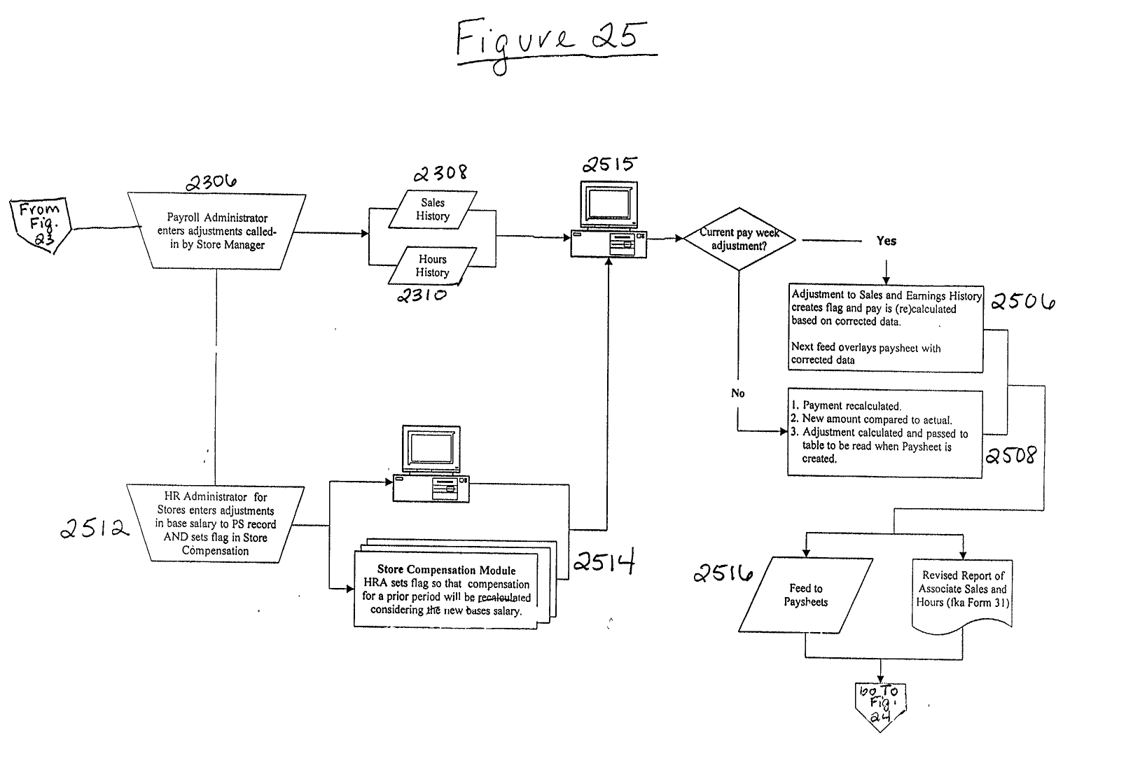

FIGS. 23, 24 and 25 represent the process flow of the compensation system. Initially, the associate reports the hours worked on a time report 2300. Hours for associates shifted between stores will be entered at the register for the store in which the hours were worked. Next, the manager enters the hours reported on the associate's time sheets into the Point of Sale System at the store register 2302. The associate's sales are recorded at the store register 2316, and all sales and hours data, as well as human resources transactions, are uploaded to the system's main database 2318 and 2320. The sales and hours information which has been uploaded then interfaces with the Compensation Module 2322. Once interface is complete, compensation is calculated 2400.

In the event an adjustment to associate sales and hours is necessary, the manager reports such needed corrections and updates to payroll administrators 2304. Payroll then enters the changes into hours and sales databases 2306, which alters the Sales History 2308 and the Hours History 2310. When the adjustments are made, a flag is set upon interface with the compensation module 2514 and 2515. Compensation for the period will now be recalculated, and the recalculated information is compared to the actual information derived from the compensation calculation 2400. If a current pay week adjustment is needed 2506, the pay will be recalculated based on the corrected data and the next feed overlays the paysheet with the corrected data. If no adjustment is necessary 2508, the results are passed to a table to be read when the paysheet is created. The information is fed to the paysheets 2512, at which time the paysheets are created 2404.

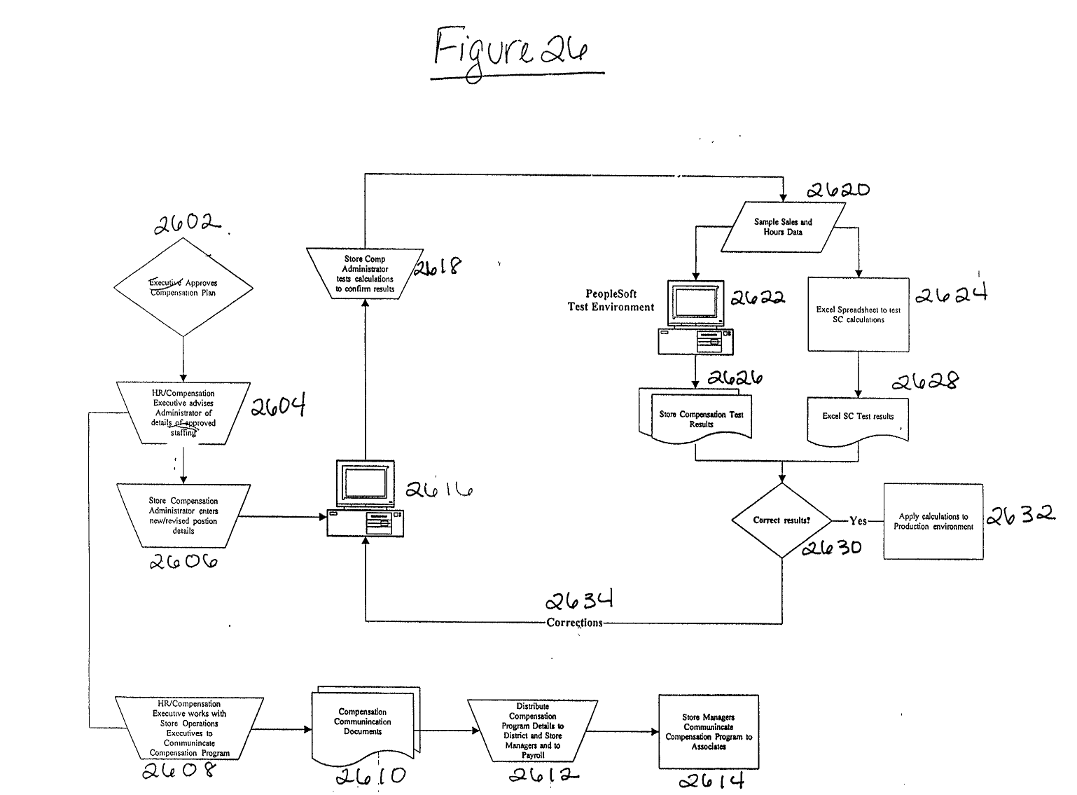

FIG. 26 is an illustration of how a company should implement and maintain the present invention. Upon executive approval 2602 of the compensation plan, the payroll administrators should be advised as to the details of the approved plan 2604. The administrators then enter the new/revised details 2606. Once the details are added, the system is run 2616, and the calculations are tested to confirm the results 1618. This is performed by entering sample sales and hours data 2620, then running this data through an Excel spreadsheet 2624 and through the present invention 2622. The results of the spreadsheet test 2628 are compared to the results of the invention 2626, and if the results are correct 2630, the calculations should be applied to the production environment 2632. If corrections 2634 are required, they can be entered as needed. It is also advisable for the corporate executives to work with store operations executives to communicate the compensation program 2608 via, for example, documents 2610. The details should be disseminated to district and store managers 2612, who in turn communicate the program to store associates 2614.

While the present invention has been described with reference to one or more preferred embodiments, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention. It should be appreciated that the present invention is capable of being embodied in other forms without departing from its essential characteristics.

What is claimed is:

1. A method for providing a store compensation system using network-based computer software applications to integrate and manipulate employee payroll and human resource information to determine and monitor employee compensation for single or multi-location companies, wherein said method comprises the steps of:
inputting employment data into a store's Point of Sale system for each employee;
recording the sales transaction data for said employee;
uploading said transaction data to a central database;
calculating the compensation due said employee; and
recalculating said compensation at predetermined times;
wherein said calculating includes base salary, commissions, overtime, premiums, bonuses and pay for time not worked; and
wherein said recalculating is done to determine the consistency of the compensation to said employee.
